(19) United States
(12) Patent Application Publication
(10) Pub. No.: US 2009/0237638 A1
(43) Pub. Date: Sep. 24, 2009

(54) EXPOSURE APPARATUS AND DEVICE MANUFACTURING METHOD

(75) Inventors: Tomofumi Nishikawara, Utsunomiya-shi (JP); Keiji Emoto, Utsunomiya-shi (JP); Tatsuya Hayashi, Utsunomiya-shi (JP); Keiji Yamashita, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/409,401

(22) Filed: Mar. 23, 2009

(30) Foreign Application Priority Data
Mar. 24, 2008 (JP) 2008-076891
Jan. 28, 2009 (JP) 2009-016217

(51) Int. Cl. G03B 27/58

(52) U.S. Cl. 355/72

(57) ABSTRACT

An exposure apparatus for exposing a substrate through liquid includes a stage for holding and moving the substrate. The stage includes a holding section for holding the substrate and a supporting section disposed around the holding section. The supporting section includes a recovery port including a gap between the substrate held by the holding section and the supporting section, the recovery port for recovering the liquid, a space for storing the liquid recovered through the recovery port, a liquid recovery mechanism for draining the liquid that has collected in a lower part of the space, and a sloshing reduction member disposed in the space, the sloshing reduction member for reducing sloshing of the liquid.

### BACKGROUND OF THE INVENTION

1. Field of the Invention

The present invention relates to an exposure apparatus that exposes a substrate through liquid and a method for manufacturing a device using the exposure apparatus.

2. Description of the Related Art

Referring to FIGS. 8A and 8B, existing immersion exposure apparatuses are described.

FIGS. 8A and 8B are schematic sectional views illustrating a state when a periphery of a wafer 40 is exposed to light. In FIG. 8A, a wafer holding section 802 supports the back side of the wafer 40 on a surface 801 and firmly fixes the wafer 40 by holding the wafer 40 with a vacuum. A support plate 843 is disposed so as to surround the wafer 40. The height of a surface 843a of the support plate 843 is substantially equal to the height of a surface of the wafer 40.

A liquid recovery mechanism is disposed in a lower part of a space 800. The liquid recovery mechanism includes a recovery port 804, a recovery pipe 805, and a suction device 806. The recovery port 804 serves to drain liquid LW that has dropped into the space 800 as shown in FIG. 8B. The recovery port 804 is connected to the suction device 806 through the recovery pipe 805.

Japanese Patent Laid-Open No. 2006/186112 describes controlling of spattering and flow of liquid by providing a hydrophilic area on a surface of a support plate. International Publication No. WO 2004/112108 pamphlet and International Publication No. WO 2006/049134 pamphlet describe a liquid recovery mechanism for recovering liquid that has dropped into a gap between the wafer and the support plate.

Referring to FIG. 8A, a first problem with existing immersion exposure apparatuses is described. The first problem is that, when a periphery of the wafer 40 is exposed to light, the liquid may be divided when liquid LW spreads over a gap, and the divided liquid d may spatter in the exposure apparatus when a wafer stage moves. The spattering of liquid may cause corrosion of peripheral components, or may form water marks and stain the exposure apparatus. To address the problem, the surface 843a of the support plate may be made hydrophilic so as to retain liquid d on the surface 843a and suppress spattering of liquid d in the exposure apparatus. With this method, however, it is difficult to recover liquid d from the surface 843a that is hydrophilic, and watermarks may be formed on the surface 843a.

Referring to FIG. 8B, a second problem is described. When a periphery of the wafer 40 is exposed to light, liquid LW drops into the space 800 through the gap g between the wafer 40 and the support plate 843. Then, when the wafer stage is driven, liquid LW may overflow through the gap g, spatter onto the support plate 843 and the wafer 40 and stain the exposure apparatus. This is the second problem. In order to solve the problem, liquid LW in the space 800 may be recovered using the suction device 806 so as to suppress overflow of liquid LW. However, this may accelerate vaporization of liquid LW, which may cause thermal deformation of peripheral components.

As heretofore described, it is important to rapidly recover liquid d divided at gap g without allowing the liquid d to spatter in the exposure apparatus, and to prevent liquid LW that has dropped into the space 800 from overflowing when the stage moves.

### SUMMARY OF THE INVENTION

The present invention provides an exposure apparatus with which one or both of the first problem and the second problems is solved and light exposure is performed with excellent precision.

According to an aspect of the present invention, an exposure apparatus for exposing a substrate through liquid includes a stage for holding and moving the substrate. The stage includes a holding section for holding the substrate and a supporting section disposed around the holding section. The supporting section includes a recovery port including a gap between the substrate held by the holding section and the supporting section, the recovery port for recovering the liquid, a space for storing the liquid recovered through the recovery port, a liquid recovery mechanism for draining the liquid that has collected in a lower part of the space, and a sloshing reduction member disposed in the space, the sloshing reduction member for reducing sloshing of the liquid.

Further aspects of the present invention will become apparent from the following description of exemplary embodiments with reference to the attached drawings.

### BRIEF DESCRIPTION OF THE DRAWINGS

FIG. 1A is a schematic sectional view of a periphery of a wafer for describing a first embodiment of the present invention.

FIG. 1B is a schematic sectional view of the periphery of the wafer for describing the first embodiment.

FIG. 1C is a schematic sectional view of the periphery of the wafer for describing the first embodiment.

FIG. 2 is a schematic sectional view of an exposure apparatus.

FIG. 3 is a schematic view for explaining an equation of motion for liquid LW.

FIG. 4 is a graph showing a relationship between hydraulic conductivity and rise value of liquid.

FIG. 5 is a schematic sectional view of a periphery of a wafer for describing a second embodiment of the present invention.

FIG. 6A is a schematic sectional view of a periphery of a wafer for describing a third embodiment of the present invention.

FIG. 6B is a schematic sectional view of the periphery of the wafer for describing the third embodiment.

FIG. 7 is a schematic perspective view of a periphery of a wafer for describing a fourth embodiment of the present invention.

FIG. 8A is a schematic sectional view of a periphery of a wafer for describing conventional arts.

FIG. 8B is a schematic sectional view of the periphery of the wafer for describing conventional arts.

### DESCRIPTION OF THE EMBODIMENTS

Hereinafter, various embodiments of the present invention are described in detail with reference to the attached drawings.

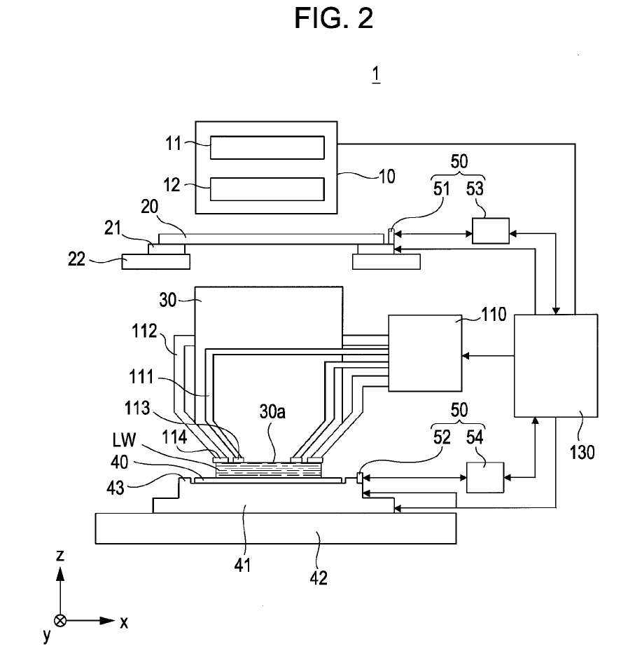

FIG. 2 is a schematic sectional view showing a structure of an exposure apparatus 1 according to a first embodiment of the present invention.

The exposure apparatus 1 is an immersion exposure apparatus that exposes a pattern of a reticle (mask) 20 onto a wafer 40 through liquid (immersion liquid) LW that is supplied between a final surface 30a of a projection optical system 30 and the wafer 40. The exposure apparatus 1 exposes the wafer 40 to light by a step-and-scan method. However, an exposure apparatus that exposes the wafer 40 to light by a step-and-repeat method can also be used.

As shown in FIG. 2, the exposure apparatus 1 includes an illumination unit 10, a reticle stage 21, the projection optical system 30, a wafer stage 41, a support plate (supporting section) 43, and a distance measuring unit 50.

The illumination unit 10 includes a light source 11 and an illumination optical system 12. In this embodiment, ArF excimer lasers with a wavelength of 193 nm are used as the light source 11. However, KrF excimer lasers of a wavelength of about 248 nm or F2 lasers with a wavelength of about 157 nm can be used as the light source 11. The illumination optical system 12 illuminates the reticle 20 with light from the light source 11.

The reticle stage 21 is mounted on a base 22 for fixing the reticle stage 21. The reticle stage 21 holds the reticle 20 with a reticle chuck (not shown). The reticle stage 21 is controlled by a movement mechanism (not shown) and a control unit described below. The reticle 20, which is made of quartz, is an original having a circuit pattern formed thereon. Diffracted light that has passed through the circuit pattern of the reticle 20 is projected onto the wafer 40 with the projection optical system 30.

The projection optical system 30 projects the pattern of the reticle 20 onto the wafer 40. A dioptric system or a catadioptric system can be used for the projection optical system 30.

The wafer stage 41 is mounted on a base 42 for fixing the wafer stage 41. The wafer stage 41 holds the wafer 40 on a wafer holding section. The wafer stage 41 functions to adjust the up-and-down (vertical) position, the orientation, and the inclination of the wafer 40. The wafer stage 41 is controlled by a stage control unit. While the wafer 40 is being exposed to light, the stage control unit controls the wafer stage 41 so that the focal plane of the projection optical system 30 coincides with the upper surface of the wafer 40 with high precision. The wafer 40 is conveyed into the exposure apparatus 1 with a wafer conveying system (not shown). The wafer 40 is supported on and moved with the wafer stage 41. Although the wafer 40 is used as a substrate in this embodiment, a liquid crystal substrate or the like can be also used as the substrate. The wafer 40 is coated with a photoresist.

The support plate 43 surrounds the wafer 40. The height of the upper surface of the support plate 43 is adjusted so as to be substantially the same height as the upper surface of the wafer 40. The support plate 43 and the wafer 40 support the liquid LW when an edge of the wafer 40 is exposed to light.

The distance measuring unit 50 measures in real time the position of the reticle stage 21 and the three-dimensional position of the wafer stage 41 using reference mirrors 51 and 52 and laser interferometers 53 and 54. Measurements made by the distance measuring unit 50 are transmitted to a control unit 130 described below. The reticle stage 21 and the wafer stage 41 are driven and positioned under control by the control unit 130.

The liquid LW can be selected, for example, from substances having a low absorptance for the light used for exposure and having a refractive index as high as possible. As more specific examples, pure water, functional water, a fluoridized liquid (for example, a fluorocarbon), an organic liquid, or the like may is used as the liquid LW. Dissolved gas in the liquid LW can be sufficiently removed using a degassing apparatus. As the liquid LW, liquid including water with a very small amount of additives or hydrocarbon organic liquid can also be used.

The exposure apparatus 1 further includes a supply/recovery unit 110 and the control unit 130.

The supply/recovery unit 110 supplies the liquid LW to and recovers the liquid LW from between the wafer 40 and the final surface 30a of the projection optical system 30 through a supply pipe 111, a recovery pipe 112, a supply nozzle 113, and a recovery nozzle 114. The supply/recovery unit 110, which has a structure for supplying and recovering the liquid LW, is controlled by the control unit 130. The supply/recovery unit 110 also supplies and recovers the liquid LW when the wafer stage 41 moves. With the above-described structure, the supply/recovery unit 110 can remove dissolved gas and impurities from the liquid LW, and the liquid LW is maintained in a homogeneous state.

The control unit 130, which includes a CPU (not shown) and a memory, controls the exposure apparatus 1. The control unit 130 is electrically connected to the illumination unit 10, the movement mechanism (not shown) for the reticle stage 21, a movement mechanism (not shown) for the wafer stage 41, and the supply/recovery unit 110. For example, the control unit 130 may be configured to supply and recover the liquid LW by switching the flow direction of the liquid LW in accordance with the wafer stage 41 when light exposure is performed. Alternatively, the control unit 130 may be configured to supply and recover the liquid LW in a constant amount when light exposure is performed.

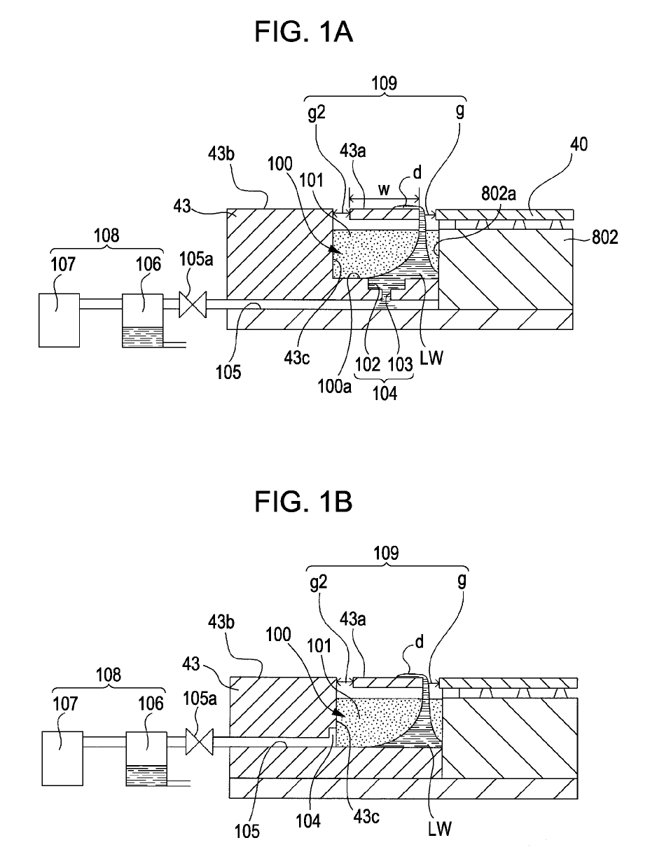

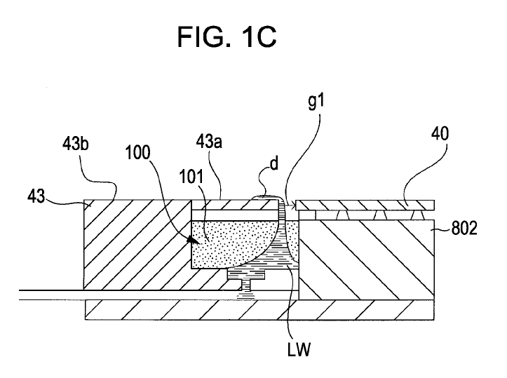

Referring to FIGS. 1A to 1C, a method for recovering liquid d that has been divided and a method for suppressing an overflow of the liquid LW that has dropped into a space 100 in this embodiment is described below. FIGS. 1A to 1C are schematic sectional views of a periphery of the wafer 40 for describing the first embodiment.

First, a structure around the periphery of the wafer 40 in this embodiment is described. A surface of the support plate 43 includes a first area 43a that is hydrophilic and a second area 43b that is hydrophobic (liquid-repellent). The first area 43a is made of hydrophilic material (for example, SiO2, SiC, or a metal oxide such as titanium oxide). Lateral sides of the first area are also hydrophilic. The first area 43a surrounds the wafer 40. The first area 43a has a width w in the range of several millimeters to several tens of millimeters. The width of a gap g between the wafer 40 and the first area 43a is adjusted so as to be approximately between 0.1 mm to 2 mm. The second area 43b surrounds the first area 43a. A gap g2 is formed between the first area 43a and the second area 43b. The second area 43b is coated with Teflon or treated by a hydrophobic treatment such as PFA.

The gap g2 and the gap g provide recovery ports 109 for recovering the liquid d and allow the liquid d to be recovered from the surface of the support plate 43 to the space 100 therethrough. A side surface 43c of the support plate 43 is made hydrophilic so that the liquid d can be smoothly recovered to the space 100. As hydrophilic treatment, titanium oxide coating, for example, can be used. Moreover, a side surface of the wafer 40 and a side surface 802a of the wafer holding section 802 may be made hydrophilic. Furthermore, the liquid d can be recovered more effectively by disposing a recovery port for recovering the liquid d in the first area 43a. For example, slits, pinholes, or a porous body may be formed in the first area 43a.

The space 100 is formed in the support plate 43 in a ring shape so as to surround the wafer 40 so that liquid recovered through the recovery ports 109 can be temporarily stored therein.

A porous body 101, which serves as a sloshing reduction member, has a ring shape so as to surround the wafer 40 and has a volume equal to or larger than half the volume of the space 100. In this embodiment, the porous body 101 occupies a space from a space bottom 100a to near the first area 43a. As the porous body 101, for example, SiO2, SiC, or a sintered compact of metal such as stainless steel or titanium can be used. Hydraulic conductivity is an indicator of the permeability of a porous body. Hydraulic conductivity is a coefficient defined by Darcy's law expressed by equation 1. Here, v is apparent seepage flow velocity (cm/sec), k is hydraulic conductivity (cm/sec), and i is hydraulic gradient.

v=ki (1)

The porous body 101 in this embodiment has a hydraulic conductivity equal to or lower than 1000 cm/sec for the reasons described below.

A liquid recovery mechanism 104 is a mechanism for draining liquid that has collected in the space 100. In this embodiment, the liquid recovery mechanism 104 includes a groove 102 and pinholes 103 disposed in the lower part of the space 100. The groove 102, which is formed in the space bottom 100a, has a ring shape so as to surround the wafer 40. The groove 102 serves to guide the liquid LW that has infiltrated into the porous body 101 to the pinholes 103. The pinholes 103 have a diameter in the range from several hundred micrometers to several tens of millimeters. The pinholes 103 are disposed in the groove 102. In this embodiment, the pinholes 103 are disposed at equally spaced intervals along the circumference of the wafer 40. The groove 102 is not necessary when a large number of the pinholes 103 are provided, because the liquid LW that has infiltrated into the porous body 101 is easily drained to the pinholes 103 in this case. The liquid recovery mechanism 104 is disposed near the center of the space bottom 100a or below the recovery ports 109. In order to effectively drain the liquid LW, the space bottom 100a may be inclined downward toward the liquid recovery mechanism 104.

As shown in FIG. 1B, the liquid recovery mechanism 104 may be disposed in the side surface 43c of the support plate 43. Because the liquid LW is collected on the space bottom 100a by gravitation, the liquid LW can be drained as in the configuration shown in FIG. 1A.

A recovery pipe 105 guides liquid from the liquid recovery mechanism 104 to a suction device 108. The suction device 108 includes a gas-liquid separation unit 106 and a decompressor 107.

Next, some of the advantages of this embodiment are described.

While a periphery of the wafer 40 is being exposed to light (edge shot), liquid may be divided when an immersion area spreads over the gap g. However, in this embodiment, the liquid d that has been divided remains on the first area 43a because the first area 43a is hydrophillic, whereby spattering of the liquid d is reduced. Therefore, corrosion of peripheral components and formation of water marks resulting from spattering of the liquid d can be reduced.

Moreover, the liquid d on the first area 43a is drained to the space 100 through the recovery ports 109. Therefore, evaporation of the liquid d on the first area 43a and the formation of water marks resulting therefrom can be reduced.

Although the first area 43a is made hydrophilic in this embodiment, the first area 43a may be made hydrophobic in a case when liquid is not divided or in a case when only a small amount of liquid is divided. In this case, the contact angle between the first area 43a and the surface of liquid is equal to the contact angle between the second area 43b and the surface of liquid. Moreover, the surface of the support plate 43 may be constituted by a single region without the gap g2.

As shown in FIG. 1C, in the case when only a small amount of liquid is divided, the first area 43a that is hydrophilic and the second area 43b that is hydrophobic may be formed continuously. Although the gap g2 is not provided in this case, the liquid d on the hydrophilic first area 43a can be sufficiently recovered through a gap g1, since the amount of the liquid d is small. For example, the first area 43a and the second area 43b of the support plate 43 may be integrally formed from a hydrophilic material such as SiC, and only the second area 43b may be treated by hydrophobic treatment with Teflon (registered trademark) or the like. By integrally forming the first area 43a and the second area 43b, formation of a difference in height or a gap between the first area 43a and the second area 43b can be prevented, whereby the state of the liquid LW can be maintained stably when the wafer stage 41 moves at a higher velocity.

The liquid LW enters from the recovery ports 109, passes through the porous body 101, and collects in the space 100. A material having a sufficiently high permeability is used for the porous body 101.

The liquid LW that has collected in the space 100 may overflow through the recovery ports 109 when the wafer stage 41 moves. However, sloshing of the liquid LW is reduced in this embodiment since the porous body 101 is disposed in the space 100. As a result, overflow of the liquid LW from the recovery ports 109 can be reduced. Actually, overflow of the liquid LW is reduced when hydraulic conductivity of the porous body 101 is equal to or less than 1000 cm/sec. In particular, it is beneficial to reduce overflow of the liquid LW for this embodiment, because the liquid easily drops into the space 100 since the first area 43a is hydrophilic.

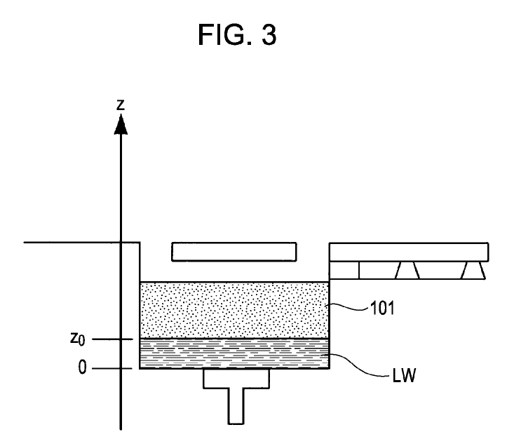

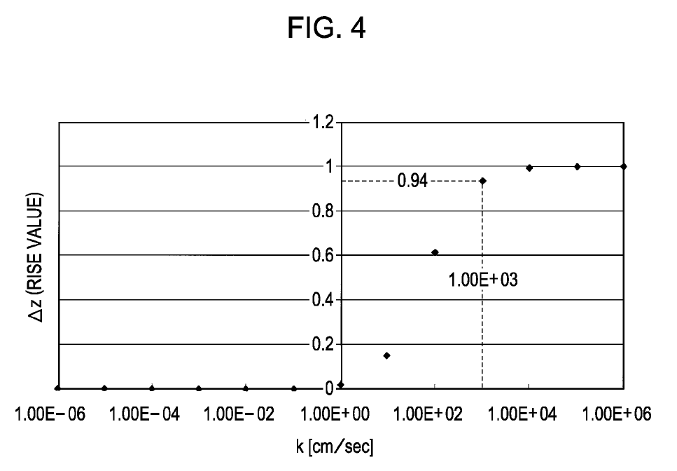

Next, referring to equations 2 to 5 and FIGS. 3 and 4, measures for reducing overflow of the liquid LW are described.

When the Z coordinate is taken as shown in FIG. 3, the equation of motion for the liquid LW using hydraulic conductivity can be expressed by equation 2. The solution to this equation of motion is given by equation 3.

$$ρ \frac{{d}^{2} z ( t )}{d {t}^{2}} = - ρ g - \frac{ρ g}{k} \frac{d z ( t )}{d t} , \\ \frac{d z ( 0 )}{d t} = {v}_{0} , \\ z ( 0 ) = {z}_{0} \qquad ( 2 )$$

z(t) [m]: Vertical position of liquid LW
ρ [kg/m³]: Density of liquid
g: Acceleration of gravity 9.8 m/s²
k [cm/s]: Hydraulic conductivity

$$z ( t ) = {z}_{0} - τ ( {v}_{0} + \frac{k}{100} ) ( {e}^{- t / τ} - 1 ) - \frac{k}{100} t , \\ τ = \frac{k}{100 g} \qquad ( 3 )$$

Here, maximum value of Z is expressed by equation 4. The maximum rise value Δz of the liquid LW resulting from sloshing of the liquid caused by the movement of the wafer stage 41 is expressed by equation 5.

$$\begin{matrix}{z}_{max} ( k ) = {z}_{0} + {v}_{0} τ - \frac{k}{100} τln ( 1 + \frac{100 {v}_{0}}{k} ) & ( 4 ) \\ Δ z = \frac{{z}_{max} ( k ) - {z}_{0}}{{z}_{max} ( ∞ ) - {z}_{0}} & ( 5 )\end{matrix}$$

The relation between hydraulic conductivity k and a rise value of the liquid Δz is illustrated in the graph of FIG. 4. Δz is a value obtained by normalizing the rise value of the liquid LW (maximum value of z−initial value of z) [m] with the rise value of the liquid LW (maximum value of z−initial value of z)=v₀²/(2 g) [m] when the porous body 101 is not present (corresponding to k=∞). Here, the initial velocity v₀ is set to be 1 m/s, because v₀ is at most comparable to the velocity of the movement of the wafer stage 41. It can be seen from FIG. 4 that the rise of the liquid LW is effectively reduced when the hydraulic conductivity of the porous body is lower than 1000 cm/s.

In this embodiment, it is not necessary to continuously suck and recover the liquid LW through the liquid recovery mechanism 104, because the liquid LW collected in the space 100 does not overflow. For example, suction recovery of the liquid LW may be stopped by closing a valve 105a shown in FIGS. 1A and 1B while the wafer 40 is being exposed to light, and suction recovery of the liquid LW may be restarted by opening the valve 105a after light exposure (when light exposure is not performed). Alternatively, the power of suction recovery may be reduced during light exposure and increased after light exposure (when light exposure is not performed). As a result, the influence of heat of vaporization resulting from suction recovery can be reduced during light exposure.

As heretofore described, since the exposure apparatus 1 of this embodiment has the first area 43a that is hydrophilic and the recovery ports 109 on the surface of the support plate 43, the liquid d can be recovered to the space 100 without allowing the liquid d to spatter in the exposure apparatus 1. Moreover, since the porous body 101 is disposed in the space 100, the liquid LW is prevented from overflowing from the space 100 as the stage moves. As a result, corrosion of components near the wafer and formation of water marks can be suppressed, and staining of the exposure apparatus 1 can be reduced. Moreover, since it is not necessary to constantly suck the liquid that has collected in the space 100, heat of vaporization can be reduced, whereby decline of exposure accuracy caused by the heat of vaporization can be suppressed.

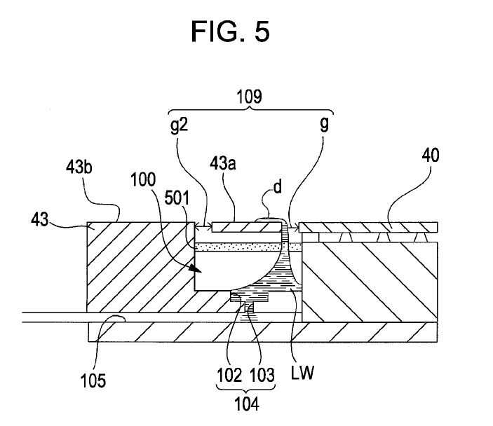

Referring to FIG. 5, a second embodiment of the present invention is described below. FIG. 5 is a schematic sectional view of the periphery of the wafer 40 corresponding to FIGS. 1A and 1C. In the following description, the same numerals are used for the components that are the same as or similar to those in the first embodiment, and redundant description of such components is avoided.

In FIG. 5, a porous body 501 having a thickness of several millimeters is disposed in the upper part of the space 100 so as to serve as a sloshing reduction member. To be specific, the porous body 501 is disposed in the upper half of the space 100 in this embodiment. Liquid d is drained through the recovery ports 109, passes through the porous body 501, and is recovered to the space bottom 100a. Sloshing of the liquid LW caused by the movement of the wafer stage 41 is reduced with the porous body 501. As a result, the liquid LW does not overflow from the recovery ports 109. It is beneficial that the hydraulic conductivity of the porous body 501 be higher than 1000 cm/sec for the above-described reason. The liquid LW that has collected on the space bottom 100a is recovered to the recovery pipe 105 through the liquid recovery mechanism 104.

Although the porous body 501 is used as a sloshing reduction member in the foregoing description, a porous plate having pinholes therein can also be used as a sloshing reduction member. The porous plate has a thickness of several millimeters, and the diameter of the pinholes is in the range from several hundred micrometers to several millimeters. By treating the porous plate by hydrophilic treatment, liquid can be easily drained to the space 100 through the pinholes.

As described above, since an exposure apparatus of this embodiment has a porous body or a porous plate as a sloshing reduction member in the upper part of the space 100, liquid d can be recovered through the recovery ports 109 and sloshing of the liquid LW in the space 100 can be reduced. As a result, the liquid LW is prevented from overflowing from the recovery ports 109, and spattering of liquid in the exposure apparatus can be suppressed.

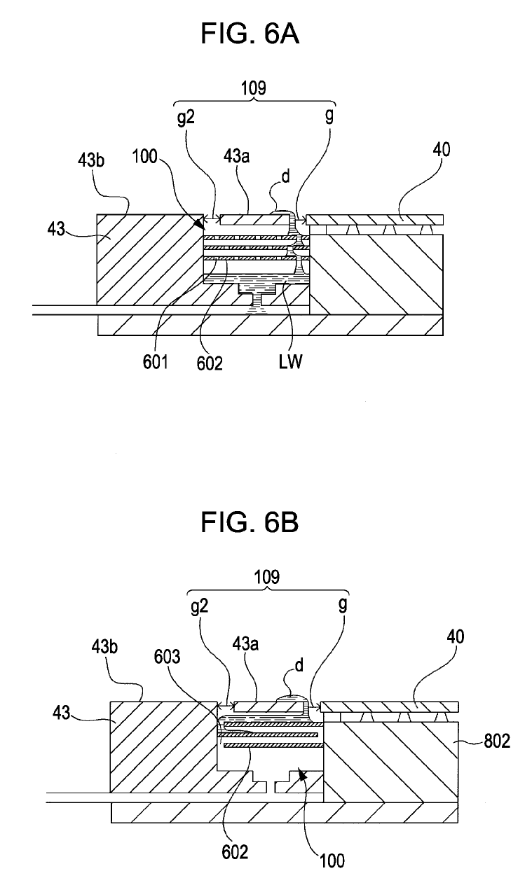

Referring to FIGS. 6A and 6B, a third embodiment of the present invention is described below. FIGS. 6A and 6B are schematic sectional views corresponding to FIGS. 1A to 1C. In the following description, the same numerals are used for the components that are the same as or similar to those in the first embodiment, and redundant description of such components is avoided.

As shown in FIG. 6A, in this embodiment, plates 602 having pinholes 601 are disposed in the space 100 in a multi-tiered manner so as to serve as a sloshing reduction member. The diameter of the pinholes 601 is in the range of several hundred micrometers to several of millimeters. Although the number of plates 602 is three in this embodiment, the number of plates 602 can be reduced by reducing the diameter of the pinholes 601. The number of plates 602 may be appropriately set in accordance with the diameter of the pinholes 601. Liquid d is recovered through the recovery ports 109 and collects in the space 100 through the pinholes 601 of the plates 602. When the wafer stage 41 moves, sloshing of liquid is suppressed with the multi-tiered plates 602, whereby overflow of the liquid through the recovery ports 109 is suppressed. By positioning the pinholes 601 of vertically adjacent plates 602 in a staggered manner, sloshing of liquid LW can be effectively suppressed. The diameter of the pinholes 601 may become smaller from the upper plates to the lower plates.

In the foregoing description, the plates 602 with the pinholes 601 are used as multi-tiered plates so as to reduce sloshing of liquid. However, as shown in FIG. 6B, openings 603 may be formed between the plates 602 and the support plate 43, or between the plates 602 and the wafer holding section 802. In this case, since the positions of the openings 603 formed with vertically adjacent plates 602 are staggered, sloshing of liquid LW can be suppressed effectively.

In this embodiment, the plates 602 may be hydrophilic. In this case, liquid d recovered through the recovery ports 109 can be quickly drained to the lower part of the space 100.

As heretofore described, since the exposure apparatus of this embodiment has the multi-tiered plates 602 with openings in the space 100 as a sloshing reduction member, liquid d can be recovered through the recovery ports 109 and sloshing of liquid LW in the space 100 can be reduced. As a result, overflow of liquid LW through the recovery ports 109 and spattering of liquid LW in the exposure apparatus can be suppressed.

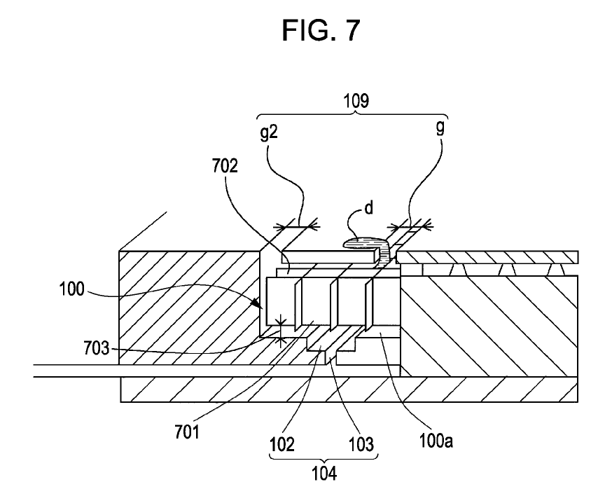

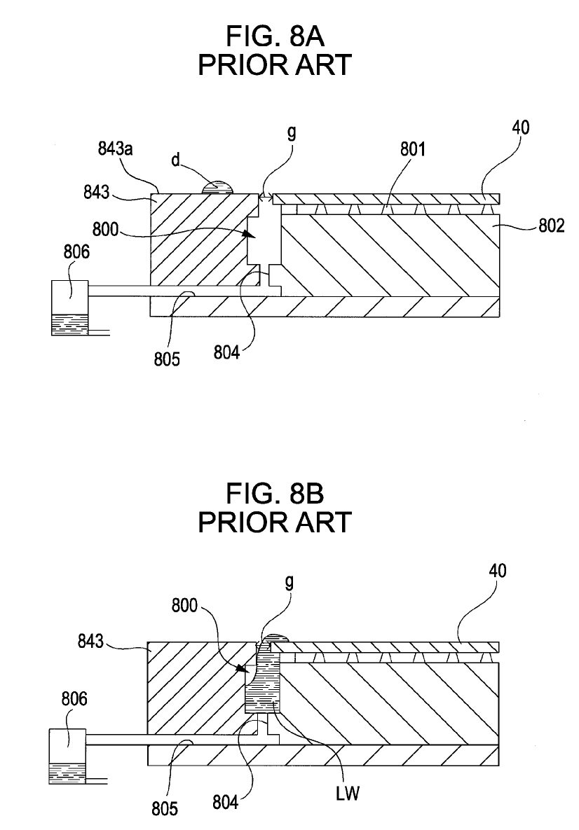

Referring to FIG. 7, a fourth embodiment of the present invention is described below. FIG. 7 is a schematic perspective view corresponding to FIGS. 1A to 1C. In the following description, the same numerals are used for the components that are the same as or similar to those in the first embodiment, and redundant description of such components is avoided.

In this embodiment, partition plates 701 serving as a sloshing reduction member divides the space 100 into a plurality of spaces 702. As shown in FIG. 7, the partition plates 701 are disposed in the radial direction and the circumferential direction. The number of partition plates 701 may be determined appropriately in accordance with the viscosity of liquid LW and dimensions of the wafer stage 41 and the space 100. A gap 703 is formed between the partition plates 701 and the space bottom 100a. The size of the gap 703 is in the range from several hundred micrometers to several millimeters. With this structure, liquid d is recovered through the recovery ports 109 and collects in the space 100 through the divided spaces 702, whereby the liquid can spread all over the lower part of the space 100. As a result, the liquid recovery mechanism 104 can recover the entire liquid d in the space 100 through the groove 102. Because the partition plates 701 are hydrophilic, liquid d can be recovered rapidly.

When the wafer stage 41 moves, the partition plates 701 serve to reduce sloshing of the liquid and suppress overflow of the liquid through the recovery ports 109.

Although the partition plates 701 are disposed in the radial direction and the circumferential direction of the wafer 40 in this embodiment, the partition plates 701 may be disposed in only one of the directions. It is not necessary that the partition plates 701 be disposed in the radial direction or in the circumferential direction as long as the space 100 is divided into a plurality of spaces.

As heretofore described, since the exposure apparatus of this embodiment has the partition plates 701 serving as a sloshing reduction member in the space 100, liquid d can be recovered through the recovery ports 109, and sloshing of liquid LW in the space 100 can be reduced. As a result, overflow of liquid LW through the recovery ports 109 and spattering of liquid LW in the exposure apparatus can be suppressed.

Next, a method for manufacturing a device (semiconductor device, liquid crystal display device, or the like) according to another embodiment of the present invention is described. A method for manufacturing a semiconductor device is used as an example here.

A semiconductor device is manufactured by a front-end process by which an integrated circuit is formed on a wafer and a back-end process by which chips of the integrated circuit formed by the front-end process are finished into a product. The front-end process includes a process for exposing a substrate coated with a photoresist to light using any of the above-described exposure apparatuses of the present invention and a process for developing the substrate. The back-end process includes an assembly process (dicing and bonding) and a packaging process.

With the device manufacturing method of this embodiment, a device having a quality higher than the existing device can be manufactured.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2008-076891 filed Mar. 24, 2008 and No. 2009-016217 filed Jan. 28, 2009, which are hereby incorporated by reference herein in their entirety.

What is claimed is:

1. An exposure apparatus for exposing a substrate through liquid, the exposure apparatus comprising:
a stage for holding and moving the substrate,
wherein the stage includes a holding section for holding the substrate and a supporting section disposed around the holding section,
wherein the supporting section includes
a recovery port including a gap between the substrate held by the holding section and the supporting section, the recovery port for recovering the liquid
a space for storing the liquid recovered through the recovery port,
a liquid recovery mechanism for draining the liquid that has collected in a lower part of the space, and
a sloshing reduction member disposed in the space, the sloshing reduction member for reducing sloshing of the liquid.

2. The exposure apparatus according to claim 1,
wherein a surface of the supporting section includes a first area that is hydrophilic and a second area that is hydrophobic.

3. The exposure apparatus according to claim 1,
wherein the sloshing reduction member includes a porous body having a hydraulic conductivity equal to or less than 1000 cm/sec, and
the volume of the porous body is equal to or more than half the volume of the space.

4. The exposure apparatus according to claim 1,
wherein the sloshing reduction member includes at least one of a porous body and a porous plate, the at least one of the porous body and the porous plate having a hydraulic conductivity equal to or less than 1000 cm/sec, the at least one of the porous body and the porous plate disposed in the upper half of the space.

5. The exposure apparatus according to claim 1,
wherein the sloshing reduction member includes a plurality of plates having openings, and
the plurality of plates are disposed in a multi-tiered manner.

6. The exposure apparatus according to claim 1,
wherein the sloshing reduction member includes a plurality of partition plates, and
the plurality of partition plates divide the space.

7. The exposure apparatus according to claim 1,
wherein the liquid recovery mechanism recovers the liquid only when the substrate is not being exposed.

8. A method for manufacturing a device, the method comprising:
exposing a substrate using an exposure apparatus for exposing a substrate through liquid, the exposure apparatus including a stage for holding and moving the substrate, wherein the stage includes a holding section for holding the substrate and a supporting section disposed around the holding section, and wherein the supporting section includes a recovery port including a gap between the substrate held by the holding section and the supporting section, the recovery port for recovering the liquid, a space for storing the liquid recovered through the recovery port, a liquid recovery mechanism for draining the liquid that has collected in a lower part of the space, and a sloshing reduction member disposed in the space, the sloshing reduction member for reducing sloshing of the liquid; and
developing the substrate that has been exposed.
